(19) United States
(12) Patent Application Publication
(10) Pub. No.: US 2018/0074212 A1
(43) Pub. Date: Mar. 15, 2018

(54) METHODS AND SYSTEMS FOR PROCESSING A GLOBAL NAVIGATION SATELLITE SYSTEM SIGNAL

(71) Applicant: QUALCOMM Incorporated, San Diego, CA (US)

(72) Inventors: Urs Niesen, Summit, NJ (US); Lionel Jacques Garin, Palo Alto, CA (US); Jubin Jose, Belle Mead, NJ (US)

(21) Appl. No.: 15/265,754

(22) Filed: Sep. 14, 2016

(51) Int. Cl. G01S 19/44; G01S 19/29; G01S 19/05

(52) U.S. Cl. CPC G01S 19/44; G01S 19/05; G01S 19/29

(57) ABSTRACT

Disclosed are devices, systems and methods for processing satellite positioning system (SPS) signals for performing positioning operations. In particular, devices, systems disclosed herein are directed to determining estimates of undifferenced ambiguity values of a plurality of received SPS signals; and solving for a time based, at least in part, on the estimates of undifferenced ambiguity values.

### BACKGROUND

### Field

Embodiments described herein are directed to obtaining measurements of signals received at a mobile receiver.

### Information

Satellite positioning systems (SPSs), such as the global positioning system (GPS), have enabled navigation services for mobile handsets in outdoor environments. A mobile receiver capable of acquiring signals transmitted by an SPS to obtain a position fix. In particular, a mobile device may acquire SPS signals to obtain carrier phase or code phase measurements for use in obtaining a position fix or performing other positioning operations.

### SUMMARY

Briefly, one particular implementation is directed to a method, at a computing device, comprising: determining estimates of undifferenced ambiguity terms of a plurality of received satellite positioning system (SPS) signals; and solving for a time based, at least in part, on the estimates of undifferenced ambiguity terms.

Another particular implementation is directed to a computing device comprising: a communication interface; and one or more processors configured to: determining estimates of undifferenced ambiguity terms of a plurality of received satellite positioning system (SPS) signals based, at least in part, on measurements or observations of carrier phases of the SPS signals obtained at the communication interface; and solve for a time based, at least in part, on the estimates of undifferenced ambiguity terms.

Another particular implementation is directed to a non-transitory storage medium comprising computer-readable instructions stored thereon which are executable by one or more processors of a computing device to: determine estimates of undifferenced ambiguity terms of a plurality of received satellite positioning system (SPS) signals; and solve for a time based, at least in part, on the estimates of undifferenced ambiguity terms.

Another particular implementation is directed to a computing device comprising: means for determining estimates of undifferenced ambiguity terms of a plurality of received satellite positioning system (SPS) signals; and means for solving for a time based, at least in part, on the estimates of undifferenced ambiguity terms.

It should be understood that the aforementioned implementations are merely example implementations, and that claimed subject matter is not necessarily limited to any particular aspect of these example implementations.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a system diagram illustrating certain features of a system containing a mobile device, in accordance with an implementation;

FIG. 2 is a flow diagram of a procedure to process measurements according to particular embodiments;

FIG. 3 is a schematic block diagram illustrating an exemplary device, in accordance with an implementation; and

FIG. 4 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

The Global Positioning System (GPS), and other like satellite positioning systems (SPSs), have enabled navigation receivers on mobile devices to process signals from transmitters aboard space vehicles (“SPS signals”) to obtain location estimates and/or navigation solutions based, at least in part, on estimates of range between the transmitters and a navigation receiver. For example, by processing SPS signals to obtain pseudorange measurements to four or more measuring transmitters at known locations, a mobile device may estimate its location using well known techniques. Other techniques may be used to obtain a more precise estimate of location based on detections of carrier phase of SPS signals transmitted by multiple transmitters. Here, ranges to transmitters may be estimated based, at least in part, on highly ambiguous carrier phrase measurements by resolving ambiguities using techniques such as integer fixing.

However, carrier phase measurements at a receiver may be corrupted by clock bias, which may complicate techniques such as integer fixing. One technique to remove clock bias includes computing differences between carrier phase measurements to cancel common receiver clock bias. This approach, however, has several drawbacks including, for example, requirements that more than one SPS satellite is in view in an epoch. Techniques described herein are directed to computing ambiguity terms with carrier phase measurements and common receiver clock bias using carrier phase measurements that are not differenced.

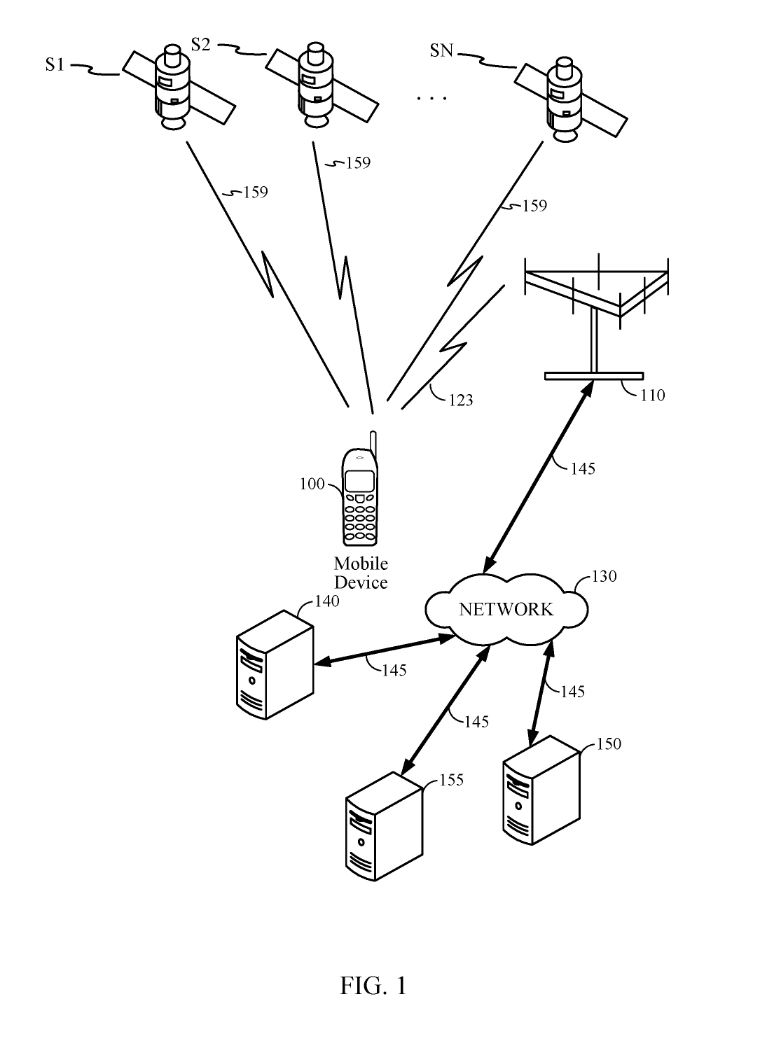

FIG. 1 is a system diagram illustrating certain features of a system containing a mobile device (MD) 100, in accordance with an implementation. An MD 100 may receive or acquire satellite positioning system (SPS) signals 159 from SPS satellites S1 through SN. In some implementations, SPS satellites S1 through SN may be from one global navigation satellite system (GNSS), such as the GPS or Galileo satellite systems. In other implementations, the SPS Satellites may be from multiple GNSS such as, but not limited to, GPS, Galileo, Glonass, or Beidou (Compass) satellite systems. In other implementations, SPS satellites may be from any one several regional navigation satellite systems (RNSS′) such as, for example, WAAS, EGNOS, QZSS, just to name a few examples.

In addition, the MD 100 may transmit radio signals to, and/or receive radio signals from, a wireless communication network. In one example, MD 100 may communicate with a cellular communication network by transmitting wireless signals to, or receiving wireless signals from, a base station transceiver 110 over a wireless communication link 123. In alternative embodiments, features of MD 100 may be incorporated in a navigation system that is capable of operating autonomously from a cellular wireless communication system such as in a vehicle navigation system.

In a particular implementation, base station transceiver 110 may communicate with servers 140, 150 and/or 155 over a network 130 through links 145. Here, network 130 may comprise any combination of wired or wireless links. In a particular implementation, network 130 may comprise Internet Protocol (IP) infrastructure capable of facilitating communication between MD 100 and servers 140, 150 or 155 through local transceiver 115 or base station transceiver 110. In another implementation, network 130 may comprising cellular communication network infrastructure such as, for example, a base station controller or master switching center to facilitate mobile cellular communication with MD 100.

In particular implementations, and/or as discussed below, MD 100 may have circuitry and/or processing resources capable of computing a position fix or estimated location of MD 100. For example, MD 100 may compute a position fix based, at least in part, on estimates of range to four or more of SPS satellites S1 through SN. Here, MD 100 may compute such estimates of range may be based, at least in part, on pseudonoise code phase detections in signals 159 acquired from four or more SPS satellites S1 though SN. In particular implementations, MD 100 may receive from server 140, 150 or 155 positioning assistance data to aid in the acquisition of signals 159 transmitted by SPS satellites S1 through SN including, for example, almanac, ephemeris data, Doppler search windows, just to name a few examples. Alternatively, as discussed below, estimates of range to an SPS satellite may be determined, at least in part, by obtaining carrier phase measurements and computing ambiguity values or terms.

According to an embodiment, an SPS receiver may obtain two types of measurements from an acquired SPS signal: code phase and carrier phase. A code phase measurement may have a noise standard deviation on the order of 1.0 m. A carrier phase measurement, on the other hand, may be much more precise, having a noise standard deviation on the order of 1.0 cm. However, a carrier phase measurement, by itself, is indicative of a range only up to an unknown ambiguity term. Here, an estimate of range between the transmitter and receiver may be expressed as some integer times a carrier wavelength, plus a carrier phase. According to an embodiment, an unknown ambiguity term for a carrier phase measurement may be determined using an integer fixing technique.

As pointed out above, carrier-phase measurements may be corrupted by a common and time-varying unknown receiver clock bias, which may complicate integer fixing techniques for determining integer ambiguity terms. According to an embodiment, one technique for removing or cancelling receiver clock bias involves choosing a reference satellite, and to subtract the carrier-phase of the reference satellite from all other carrier-phase measurements. Thus, if satellites S1 through SN are visible to mobile device 100, N−1 differenced carrier-phase measurements may be obtained. As pointed out above, this differencing operation may remove the common receiver clock bias. Instead of solving for the N integer ambiguities, this technique may involve solving for the N−1 differenced integer ambiguities. This differencing approach, however, has the following drawbacks:

1) at least two visible satellites are required (if only one satellite is visible in an epoch, that measurement cannot be used);

2) since clock bias is removed, it is difficult to compute a precise estimate for clock bias (having a precise estimate of the receiver time is beneficial in some applications, and may be used to detect outliers and monitor the health of an estimation filter);

3) if the carrier-phase from the reference satellite experiences an outlier or a cycle slip in an epoch, it may, through the differencing operation, corrupt other carrier phases measurements in that epoch as well;

4) if the reference satellite becomes temporarily blocked (say by a building or tree), new differenced integer ambiguity terms may have to be estimated (this can lead to significant temporary loss in positioning accuracy); and

5) keeping track of changing reference satellites is cumbersome and may impose increased implementation cost.

According to an embodiment, a method is directed to solving for undifferenced ambiguity terms to express a number of whole carrier wavelengths added to a carrier phase to express a range between a transmitter and a receiver. In an implementation, a clock bias and clock drift may be estimated together along with estimates of the undifferenced ambiguities (e.g., as part of a Kalman Filter state).

According to an embodiment, undifferenced ambiguity terms are estimated and updated based, at least in part, on undifferenced observations of carrier phase. One particular advantage of this approach is that the drawbacks for implementations that employ differencing carrier phase measurements may be avoided. As such, there is no need to explicitly select an SPS signal transmitted from a particular reference satellite from which to obtain differences. Instead, a subspace selection process may be used. This may lead to a significantly easier filter implementation since there is no need to handle changing reference satellites or cycle slips/outliers on the measurements from the reference satellite. The subspace selection process may also allow for better outlier rejection due to the tighter constraints on the receiver clock.

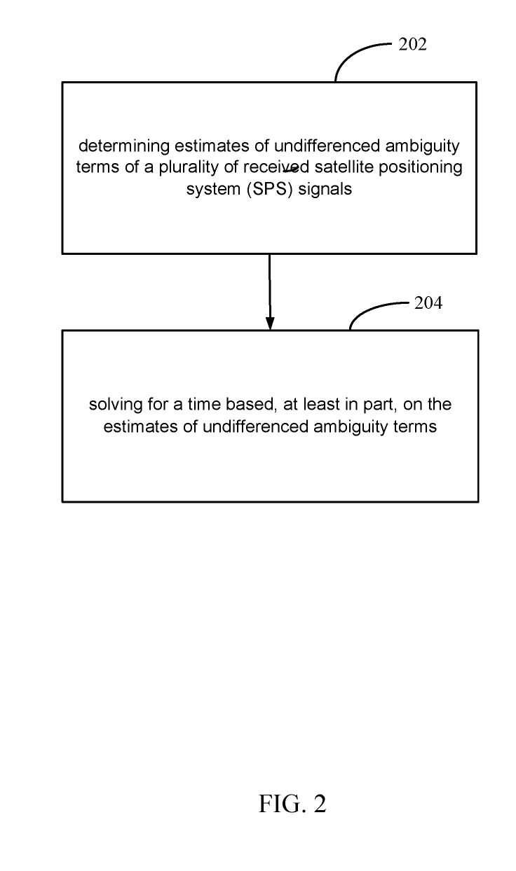

FIG. 2 is a flow diagram of a process for processing SPS signals received from SPS transmitters including determining estimates of undifferenced ambiguity terms at block 202, and then solving for a time based, at least in part, on the estimates of the undifferenced ambiguity terms at block 204. In a particular implementation, block 202 may comprise updating a state of an estimator of values in state vector such as estimates of values in a state vector shown in expression (2) below. This may be performed in a particular implementation by, for example, using a Kalman filter as set forth in expressions (3) and (4), for example. In this context, a “time” solved at block 204 may comprise any value, term, parameter, signal, etc., that is indicative of time, or is derived from time. For example, a time solved at block 204 may include, for example, a clock bias, phase estimate, estimated ambiguity term, just to provide a few examples.

According to an embodiment, a carrier phase φⁱ(t) of an SPS signal transmitted from a satellite i and acquired at a receiver may be modeled according to expression (1) as follows:

φⁱ(t) [symbol] |T_{eb}(t)−Tₑᵥⁱ(t)|+β(t)+λmⁱ(t)+z_{CP}ⁱ(t), (1)

where:

β(t) is a common receiver clock bias;

|T_{eb}(t)−Tₑᵥi(t)∥ is a difference between positions of the receiver and satellite i;

λ is the carrier signal wavelength;

mⁱ(t) is an integer ambiguity term for an SPS signal transmitted from a satellite i; and

z_{CP}ⁱ(t) is a receiver added noise term.

In this context, an “ambiguity term” as referred to herein means a quantity of carrier wavelengths separating a transmitter and a receiver. In an example implementation, an integer ambiguity term may express a number of whole carrier wavelengths that, in combination with a carrier phase, sets forth a separation between a transmitter and a receiver. Accordingly, a range separating a transmitter of a satellite i and a receiver may be estimated based on λ, and estimates of mⁱ(t) and φⁱ(t). In this context, an “undifferenced ambiguity term” means a first ambiguity term in connection with a first SPS signal received at a receiver that is not subtracted by, subtracted from, or otherwise combined with a second ambiguity term in connection with a second SPS signal received at the same receiver. In a particular implementation, an estimate of an undifferenced ambiguity term in connection with an SPS signal received at a receiver may be computed based, at least in part, on a first carrier phase measurement obtained from acquisition of a first SPS signal at the receiver that is not subtracted by, subtracted from, or otherwise combined with a second carrier phase measurement obtained from acquisition of a second SPS signal at the receiver. Similarly, an “undifferenced carrier phase observation” or “undifferenced carrier phase measurement” as referred to herein means a measurement or observation of a carrier phase of a first SPS signal received at a receiver that is not subtracted by, subtracted from, or otherwise combined with a measurement or observation of a carrier phase of a second SPS signal received at the same receiver.

According to an embodiment, ambiguity terms, clock bias, position, etc., may be estimated on iterations of a filter using a Kalman filter, for example. Such a Kalman filter may have a state according to expression (2) as follows:

$$x [ k ] {=}^{Δ} ( \begin{matrix}p [ k ] \\ ψ [ k ] \\ β [ k ] \\ m [ k ]\end{matrix} ) \qquad ( 2 )$$

where:

p[k] represents coordinates of a position at time k,

ψ[k] represents yaw angle at time k;

β[k] represents receiver clock bias at time k;

m[k] represents a vector of ambiguity terms (having integer values) for carrier phases of SPS signals transmitted by multiple different satellites in view at time k.

It should be understood that the particular elements of x[k] described above in expression (2) are merely examples, and that other embodiments may include more, fewer or different variables. According to an embodiment, a Kalman filter may be implemented to update a transition of state x[k−1] to x[k] according to expression (3) as follows:

\hat{x}[k]=A[k]\hat{x}[k−1]+K[k]y[k], (3)

where:

A[k] is a state transition matrix;

K[k] is a Kalman gain matrix based, at least in part, on computed covariance values associated with elements of x[k]; and

y[k] is a measurement vector including undifferenced carrier phase measurements φⁱ(k) for iε1, 2, . . . , N.

Here, in an embodiment, matrices A[k] and K[k] set forth aspects of linear transformations. Values in a state x[k] represented by expression (2) may be updated on iterations of a Kalman filter that receive carrier phase measurements φⁱ(t) as measurement inputs to provide an estimate of x[k] as \hat{x}[k] according to expression (3). In the particular illustrated embodiment, values for pi(t) in measurement vector y[k] comprise carrier phase measurements which are undifferenced as discussed above. Measurement vector y[k] may also comprise other type of measurements including, for example, Doppler measurements or code phase measurements, just to provide a few examples. It should be observed that while values for m[k] in expression (2) comprise integer values (representing a number of whole wavelengths to be combined with a carrier phase remainder for determining a range), a Kalman filter estimate of m[k] (e.g., included among the estimated values of \hat{x}[k]), represented as m[k], may comprise non-integer or floating point values.

As discussed below according to an embodiment, non-integer or floating point ambiguity terms in \hat{m}[k] may be mapped to corresponding integer-fixed values in an expression \hat{m}′[k] (e.g., comprising integer elements in vector). According to an embodiment, values for \hat{x}[k] in expression (3) for computing an estimate of \hat{x}[k] may be updated to replace non-integer or floating point values of \hat{m}[k] with integer-fixed values of \hat{m}′[k] according to expression (4) as follows:

\hat{x}′[k]=\hat{x}[k]+K′[k]\hat{z}[k], (4)

where:

\hat{z}[k] is an estimate of a vector z[k] representing a linear combination of actual undifferenced integer ambiguity values m[k];

K′[k] is a second Kalman gain matrix based, at least in part, on computed covariance values associated with elements of x[k]; and

\hat{x}′[k] is an update of estimate \hat{x}[k] (e.g., determined according expression (4)) to replace ambiguity terms in non-integer or floating point values of \hat{m}[k] with corresponding integer values of \hat{m}′[k].

Here, as may be observed, expression (4) provides updates of estimates of state variables of x[k] shown in expression (2) including receiver clock bias, position and ambiguity terms, among others, without computing differences of a carrier phase measurement of a reference SPS signal from carrier phase measurements of other SPS signals in an epoch.

In the particular embodiment of expression (4), integer-fixed values for \hat{m}′[k] may be computed based, at least in part, on a recognition of the linear combination z[k] of actual undifferenced integer ambiguities m[k] (e.g., a vector comprising integer elements) as the expression Fm[k]=z[k], where F is a matrix. In a particular Kalman filter implementation, as shown in expression (2) state variables may include estimated location (e.g., expressed as estimated location coordinates), estimates \hat{m}[k] of undifferenced integer ambiguity values m[k] of received SPS signals and receiver clock bias, just to provide a few examples. While actual undifferenced integer ambiguities m are integer values, estimates \hat{m} of undifferenced integer ambiguities may be expressed as floating point real values. A linear transformation (e.g., implemented as a matrix F) may produce a linear combination z[k] of actual undifferenced integer ambiguities m[k] as the expression Fm[k]=z[k]. An estimate of the linear combination \hat{z}[k] may be determined as follows:

\hat{z}[k]=arg min_{z}(F\hat{m}[k]−z)^{T}(F Σ_{\hat{m}[k]}F^{T})⁻¹(F\hat{m}[k]−z), (5)

where:

z is a vector having integer elements; and

Σ_{\hat{m}[k]} is a covariance matrix of the vector \hat{m}[k] where elements (i, j) have the form cov(\hat{m}ⁱ [k], \vec{m}^{j}[k])

Values for 2[k] determined according to expression (5) may be used to determine values for \hat{m}′[k] to be used in determining an estimate of a state \hat{x}′[k] according to expression (4) above. According to a particular implementation, values for elements of Σ_{\hat{m}[k]} may be obtained from a portion of a covariance matrix in a Kalman filter according to expression (4), for example.

According to an embodiment, values for elements of F may be determined using computation techniques including lattice reduction or decorrelation. Elements of F may be initially selected as integer values such that the expression FΣ_{\hat{m}[k]} F^{T} approximates a diagonal matrix. If an expected success rate of determining a complete set of decorrelated ambiguity terms in vector m[k] (e.g., from \hat{x}′[k]) is below an acceptable success rate, lattice reduction may be employed to resolve for a smaller subset of ambiguity terms in vector m[k] or for a smaller subset of and integer linear combinations of ambiguity terms in vector m[k]. Here, for example, elements of F may be refined by reducing a number of rows in F (with a corresponding reduction in elements of z[k]) to resolve for the smaller subset such that the expected success rate of resolving the smaller subset of ambiguity terms is at or above the acceptable success rate.

Thus, according to an embodiment, solving for a time at block 204 may include, for example, determining parameters of a linear transformation (F) between actual integer ambiguity terms of received SPS signals (m[k]) and a linear combination of the actual ambiguity terms (z[k]), determining an estimate of linear combination of the actual ambiguity terms (\hat{z}[k]) and refining the estimates of the undifferenced ambiguity terms (e.g., to provide \hat{m}′[k]) based, at least in part, on the estimate of the linear combination (\hat{z}[k]).

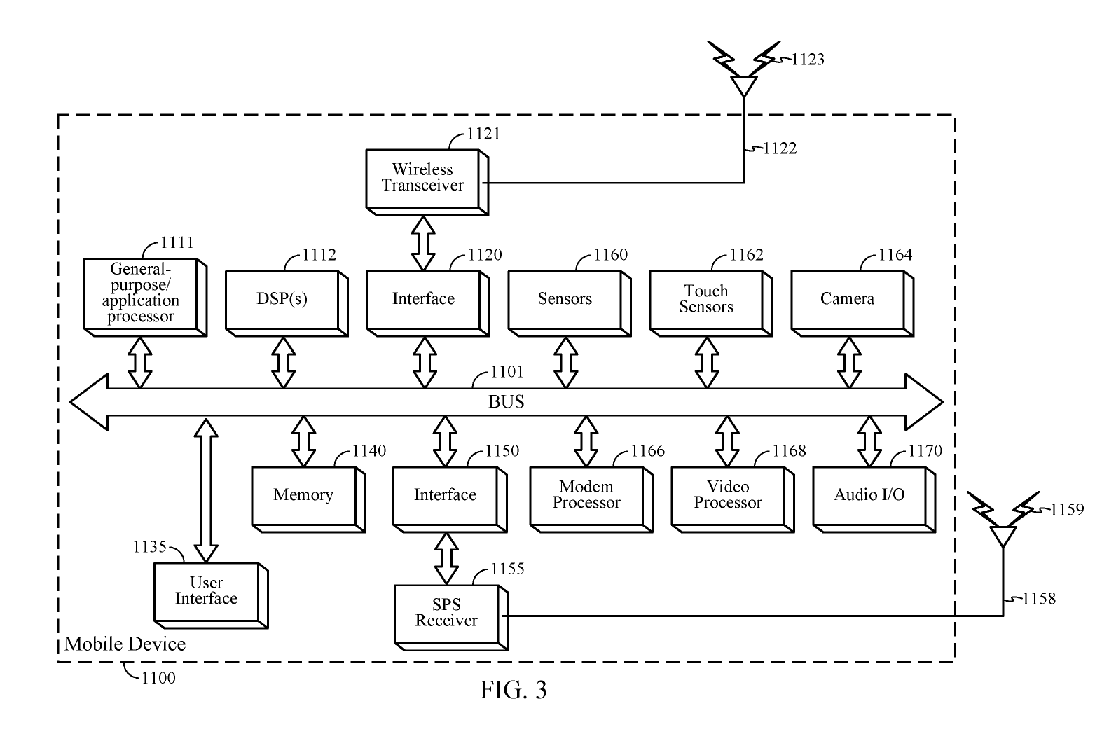

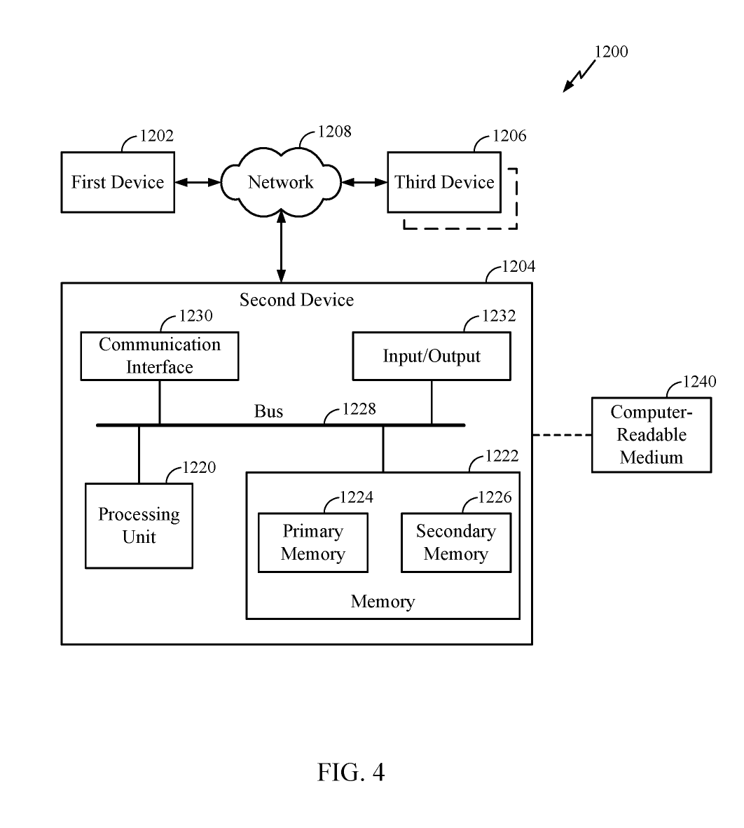

Subject matter shown in FIGS. 3 and 4 may comprise features, for example, of a computing device, in an embodiment. It is further noted that the term computing device, in general, refers at least to one or more processors and a memory connected by a communication bus. Likewise, in the context of the present disclosure at least, this is understood to refer to sufficient structure within the meaning of 35 USC § 112(f) so that it is specifically intended that 35 USC § 112(f) not be implicated by use of the term “computing device” and/or similar terms; however, if it is determined, for some reason not immediately apparent, that the foregoing understanding cannot stand and that 35 USC § 112(f) therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 2 and corresponding text of the present disclosure.

FIG. 3 is a schematic diagram of a mobile device according to an embodiment. Mobile device 100 (FIG. 1) may comprise one or more features of mobile device 1100 shown in FIG. 3. In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth, just to name a few examples.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In one particular implementation, SPS receiver 1155 may comprise phase detection circuitry (e.g., phase lock loop circuitry capable of tracking a phase of a carrier signal of an SPS signal, not shown) for obtaining observations or measurements of a carrier phase of acquired SPS signals 1159. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown). In a particular implementation general-purpose processor(s) 1111, memory 1140, DSP(s) 1112 and/or specialized processors (not shown) may also be utilized may be used to perform actions at blocks 202 and 204 including, for example, updating state variables in expression (2) using a Kalman filter as set forth in expressions (4), (5) and (6).

According to an embodiment, SPS receiver 1155 may comprise a terminal or pin to receive a blanking signal. For example, the SPS receiver 1155 may blank reception from time to time responsive to the blanking signal. In a particular implementation, wireless transceiver 1121 may be connected by a wired signal path (not shown) to the terminal or pin of SPS receiver 1155 to assert a blanking signal on the terminal or pin synchronous with content transmitted by wireless transceiver 1121 on an uplink portion of an FDD wireless communication link as discussed above.

Also shown in FIG. 3, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein. In a particular implementation, wireless transceiver 1121 may communicate with general-purpose processor(s) 1111 and/or DSP(s) 1112 through bus 1101 to enable mobile device 1100 to be configured as a wireless STA as discussed above. General-purpose processor(s) 1111 and/or DSP(s) 1112 may execute instructions to execute one or more aspects of processes discussed above in connection with FIG. 2.

Also shown in FIG. 3, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose/application processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Dedicated camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, dedicated video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose/application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, dedicated modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

FIG. 4 is a schematic diagram illustrating an example system 1200 that may include one or more devices configurable to implement techniques or processes described above. System 1200 may include, for example, a first device 1202, a second device 1204, and a third device 1206, which may be operatively coupled together through a wireless communications network 1208. In an aspect, first device 1202 may comprise a server (e.g., location server 126) capable of performing actions at blocks 202 and 204 based, at least in part, on carrier phase measurements or observations obtained a mobile receiver (e.g., mobile device 1100) and obtained in messages transmitted on wireless communications network 1208. However, claimed subject matter is not limited in scope in these respects.

First device 1202, second device 1204 and third device 1206 may be representative of any device, appliance or machine. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a base station almanac server, a base station, or a mobile device in accordance with the examples described herein.

Similarly, wireless communications network 1208, may be representative of one or more communication links, processes, or resources configurable to support the exchange of data between at least two of first device 1202, second device 1204, and third device 1206. By way of example but not limitation, wireless communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1206, there may be additional like devices operatively coupled to wireless communications network 1208.

It is recognized that all or part of the various devices and networks shown in system 1200, and the processes and methods as further described herein, may be implemented using or otherwise including hardware, firmware, software, or any combination thereof.

Thus, by way of example but not limitation, second device 1204 may include at least one processing unit 1220 that is operatively coupled to a memory 1222 through a bus 1228.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise co-located/coupled with processing unit 1220.

Processing unit 1220 may execute instructions to processes observations obtained from another device (e.g., mobile receiver device) including measurements or observations of carrier phase of SPS signals acquired at a receiver (e.g., a mobile receiver device such as mobile device 1100). In a particular implementation processing unit 1220 may execute instructions stored on primary memory 1224 to perform actions at blocks 202 and 204 including, for example, updating state variables in expression (2) using a Kalman filter as set forth in expressions (4), (5) and (6) based, at least in part, on the obtained measurements of observations of carrier phase.

Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory medium that can carry or make accessible data, code or instructions for one or more of the devices in system 1200. Computer-readable medium 1240 may also be referred to as a storage medium.

Second device 1204 may include, for example, a communication interface 1030 that provides for or otherwise supports the operative coupling of second device 1204 to at least wireless communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

As used herein, the term “mobile device” refers to a device that may from time to time have a position location that changes. The changes in position location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, bytes, values, elements, symbols, characters, terms, numbers, numerals, expressions, messages, fields, identifiers frames, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. In this context, a “wireless communication network” comprises multiple devices or nodes capable of communicating with one another through one or more wireless communication links. As shown in FIG. 1, for example, a wireless communication network may comprise two or more devices including mobile device 100 and base station 110. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples. References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn. While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method, at a computing device, comprising:
determining estimates of undifferenced ambiguity terms of a plurality of received satellite positioning system (SPS) signals; and
solving for a time based, at least in part, on the estimates of undifferenced ambiguity terms.

2. The method of claim 1, wherein the estimates of undifferenced ambiguity terms are based, at least in part, on undifferenced observations of carrier phases of the received plurality of SPS signals.

3. The method of claim 1, wherein solving for the time based, at least in part, on the undifferenced ambiguity terms further comprises:
determining parameters of a linear transformation between actual integer ambiguity terms of the received SPS signals and a linear combination of the actual integer ambiguity terms;
determining an estimate of the linear combination of the actual integer ambiguity terms; and
refining the estimates of the undifferenced ambiguity terms based, at least in part, on the estimate of the linear combination.

4. The method of claim 3, wherein determining the estimate of the linear combination further comprises determining an integer values of the linear combination that minimize an expression:
(F\hat{m}−z)^{T}(FΣ_{\hat{m}}F^{T})⁻¹(F\hat{m}−z), where:
F is a matrix comprising parameters of the linear transformation;
z is a vector of the linear combination;
\hat{m} is a vector of the undifferenced ambiguity terms; and
Σ_{\hat{m}} is a matrix of covariance values of undifferenced ambiguity terms in \hat{m}.

5. The method of claim 1, wherein determining the estimates of the undifferenced ambiguity terms further comprises determining a state of an estimator comprising at least an estimate of a position of a receiver.

6. The method of claim 5, determining the estimates of the undifferenced ambiguity terms further comprises updating the state of the estimator based, at least in part on observations of carrier phase of the SPS signals at the receiver, and wherein the estimator further comprises an estimate of clock bias of the receiver.

7. The method of claim 6, wherein the estimator further comprises the estimates of undifferenced ambiguity terms.

8. The method of claim 7, wherein the estimates of undifferenced ambiguity terms comprise non-integer or floating point values, and wherein updating the state of the estimator further comprises:
replacing undifferenced ambiguity terms in a previous state of the estimator with integer-fixed ambiguity terms to provide a modified previous state of the estimator; and
determining a current state of the estimator based, at least in part, on the modified previous state of the estimator.

9. A computing device comprising:
a communication interface; and
one or more processors configured to:
determining estimates of undifferenced ambiguity terms of a plurality of received satellite positioning system (SPS) signals based, at least in part, on measurements or observations of carrier phases of the SPS signals obtained at the communication interface; and
solve for a time based, at least in part, on the estimates of undifferenced ambiguity terms.

10. The computing device of claim 9, wherein the communication interface comprises a receiver to acquire the SPS signals to obtain the measurements or observations of carrier phases of the SPS signals.

11. The computing device of claim 9, wherein the estimates of undifferenced ambiguity terms are based, at least in part, on undifferenced observations of carrier phases of the received plurality of SPS signals.

12. The computing device of claim 9, wherein the one or more processors are configured to solve for the time by determining parameters of a linear transformation between actual integer ambiguity terms of the received SPS signals and a linear combination of the actual integer ambiguity terms; determining an estimate of the linear combination of the actual integer ambiguity terms; and refining the estimates of the undifferenced ambiguity terms based, at least in part, on the estimate of the linear combination.

13. The computing device of claim 12, wherein the one or more processors are further configured to determine the estimates of the undifferenced ambiguity terms by determining a state of an estimator comprising at least an estimate of a position of a receiver.

14. The computing device of claim 13, wherein the one or more processors are further configured to determine the estimates of the undifferenced ambiguity terms by updating the state of the estimator based, at least in part on observations of carrier phase of the SPS signals at a receiver, and wherein the estimator further comprises an estimate of clock bias of the receiver.

15. The computing device of claim 14, wherein the estimator further comprises the estimates of undifferenced ambiguity terms.

16. The computing device of claim 15, wherein the estimates of undifferenced ambiguity terms comprise non-integer or floating point values, and wherein the one or more processors are further configured to update the state of the estimator by:
replacing undifferenced ambiguity terms in a previous state of the estimator with integer-fixed ambiguity terms to provide a modified previous state of the estimator; and
determining a current state of the estimator based, at least in part, on the modified previous state of the estimator.

17. A non-transitory storage medium comprising computer-readable instructions stored thereon which are executable by one or more processors of a computing device to:
determine estimates of undifferenced ambiguity terms of a plurality of received satellite positioning system (SPS) signals; and
solve for a time based, at least in part, on the estimates of undifferenced ambiguity terms.

18. The storage medium of claim 17, wherein the estimates of undifferenced ambiguity terms are based, at least in part, on undifferenced observations of carrier phases of the received plurality of SPS signals.

19. The storage medium of claim 17, wherein the instructions are further executable by the one or more processors to solve for the time by determining parameters of a linear transformation between actual integer ambiguity terms of the received SPS signals and a linear combination of the actual integer ambiguity terms; determining an estimate of the linear combination of the actual integer ambiguity terms; and refining the estimates of the undifferenced ambiguity terms based, at least in part, on the estimate of the linear combination.

20. The storage medium of claim 19, wherein the instructions are further executable by the one or more processors to determine the estimates of the undifferenced ambiguity terms by determining a state of an estimator comprising at least an estimate of a position of a receiver.

21. The storage medium of claim 20, wherein the instructions are further executable by the one or more processors to determine the estimates of the undifferenced ambiguity terms by updating the state of the estimator based, at least in part on observations of carrier phase of the SPS signals at the receiver, and wherein the estimator further comprises an estimate of clock bias of the receiver.

22. The storage medium of claim 21, wherein the estimator further comprises the estimates of undifferenced ambiguity terms.

23. The storage medium device of claim 22, wherein the estimates of undifferenced ambiguity terms comprise non-integer or floating point values, and wherein the instructions are further executable by the one or more processors to update the state of the estimator by:
replacing undifferenced ambiguity terms in a previous state of the estimator with integer-fixed ambiguity terms to provide a modified previous state of the estimator; and
determining a current state of the estimator based, at least in part, on the modified previous state of the estimator.

24. A computing device comprising:
means for determining estimates of undifferenced ambiguity terms of a plurality of received satellite positioning system (SPS) signals; and
means for solving for a time based, at least in part, on the estimates of undifferenced ambiguity terms.

25. The computing device of claim 24, wherein means for determining the estimates of the undifferenced ambiguity terms further comprises means for determining a state of an estimator comprising at least an estimate of a position of a receiver.

26. The computing device of claim 25, means for determining the estimates of the undifferenced ambiguity terms further comprises means for updating the state of the estimator based, at least in part on observations of carrier phase of the SPS signals at the receiver, and wherein the estimator further comprises an estimate of clock bias of the receiver.

27. The computing device of claim 26, wherein the estimator further comprises the estimates of undifferenced ambiguity terms.

28. The computing device of claim 26, wherein the estimates of undifferenced ambiguity terms comprise non-integer or floating point values, and wherein the means for updating the state of the estimator further comprises:
means for replacing undifferenced ambiguity terms in a previous state of the estimator with integer-fixed ambiguity terms to provide a modified previous state of the estimator; and
means for determining a current state of the estimator based, at least in part, on the modified previous state of the estimator.

29. The computing device of claim 24, wherein the means for solving for the time based, at least in part, on the undifferenced ambiguity terms further comprises:
means for determining parameters of a linear transformation between actual integer ambiguity terms of the received SPS signals and a linear combination of the actual integer ambiguity terms;
means for determining an estimate of the linear combination of the actual integer ambiguity terms; and
means for refining the estimates of the undifferenced ambiguity terms based, at least in part, on the estimate of the linear combination.
